(19) United States
(12) Patent Application Publication
(10) Pub. No.: US 2016/0306999 A1
(43) Pub. Date: Oct. 20, 2016

(54) SYSTEMS, METHODS, AND COMPUTER-READABLE MEDIA FOR DE-IDENTIFYING INFORMATION

(71) Applicant: AURONEXUS LLC, Dade City, FL (US)

(72) Inventors: Gerald BEINHAUER, Dade City, FL (US); Benjamin MUZZIO, Dade City, FL (US)

(21) Appl. No.: 15/130,248

(22) Filed: Apr. 15, 2016

Related U.S. Application Data
(60) Provisional application No. 62/148,997, filed on Apr. 17, 2015.
(60) Provisional application No. 62/217,252, filed on Sep. 11, 2015.

(51) Int. Cl. G06F 21/62; G06F 17/30; H04L 29/06

(52) U.S. Cl. CPC G06F 21/6254; H04L 63/0421; G06F 17/30864

(57) ABSTRACT

Methods, systems, and computer-readable media for de-identifying information are described. The information de-identified using the described methods may include an information record having identifiable elements capable of identifying an individual. De-identified records may be generated by replacing identifiable elements with non-identifiable elements that may not identify the individual. Non-identifiable elements may include a secondary alias generated based on an alias pattern. In general, an alias pattern is a non-identifiable element generated based on modifying an identifiable element. A secondary alias may be created based on an alias pattern. In this manner, de-identified records may include de-identified elements (i.e., secondary aliases) that were not generated directly from identifiable elements, while allowing the records to still be aggregated and matched with related records. Furthermore, dates within the information record may be replaced with a duration based on an event to maintain a chronology of the records without revealing actual dates.

### CROSS REFERENCE TO RELATED APPLICATIONS

This application claims the benefit of U.S. Provisional Application No. 62/148,997, entitled “Systems, Methods, and Computer-Readable Media for De-Identifying Information” and filed on Apr. 17, 2015, and U.S. Provisional Application No. 62/217,252, entitled “Systems, Methods, and Computer-Readable Media for De-Identifying Information” and filed on Sep. 11, 2015, the contents of both of which are incorporated by reference in their entirety as if fully set forth herein.

### BACKGROUND

Service providers, retailers, and other businesses collect large amounts of information about their customers and the general public. This information may be used for internal business purposes or aggregated and sold to third parties for marketing and/or analytics activities. Accordingly, customer information has become a commodity. However, the collection of customer information has raised privacy concerns. In response, businesses have pledged to maintain customer anonymity and to protect their information against unauthorized use. In addition, governmental and regulatory bodies have proscribed rules for the collection, management, and sharing of collected information. In the field of healthcare, patient information is regulated according to the federal Health Insurance Portability and Accountability Act of 1996 (HIPAA). Information collected by financial service providers about their customers is regulated according to the Gramm-Leach-Bliley Act (GLBA or Financial Services Modernization Act of 1999).

One focus of data protection efforts is de-identifying information so that it cannot be used to identify an individual, business, or other entity to which the data pertains. In general, de-identified information does not contain personally identifiable elements that identify or may reasonably be used to identify an entity. Conventional de-identification methods often allow for de-identified information to be reverted to identifiable information and/or allow for the indirect identification of individuals associated with the de-identified information through minimal effort. Such de-identification methods do not provide adequate protection and, depending on the field of use, may also not comply with applicable laws or regulations. In addition, de-identified data generated through conventional techniques that comply with applicable standards are unsuitable for the robust data aggregation and analytical processing sought by data consumers. For example, certain standards require that de-identified data not include dates or times associated with the information that may be used to identify individuals or entities. As such, data consumers do not have the ability to maintain or access chronology or duration information for such de-identified data. Accordingly, entities that process and/or seek to distribute information collected from customers or the general public would benefit from a system that generates de-identified information that sufficiently protects the identity of individuals while allowing for the comprehensive application of data aggregation and analytical processing techniques and the ability to obtain chronology or duration information for the de-identified information.

### BRIEF DESCRIPTION OF THE DRAWINGS

The above and other objects of the present invention will become more readily apparent from the following detailed description taken in connection with the accompanying drawings.

FIG. 1 depicts an illustrative information management system according to an embodiment.

FIG. 2 depicts a block diagram for de-identifying information according to some embodiments.

FIG. 3 depicts a flow diagram for an illustrative method of de-identifying information according to some embodiments.

FIG. 4A depicts an illustrative sample data set that includes date and time information.

FIG. 4B depicts an illustrative data set de-identified according to some embodiments.

FIG. 5 illustrates various embodiments of a computing device for implementing the various methods and processes described herein.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for de-identifying information may include a processor and a non-transitory, computer-readable storage medium in operable communication with the processor. The computer-readable storage medium may include one or more programming instructions that, when executed, cause the processor to access at least one record comprising at least one information element, generate at least one direct alias based on the at least one information element, the at least one direct alias forming an alias pattern associated with the at least one record, associate a secondary alias with the alias pattern, and generate a de-identified record by replacing the at least one information element of the at least one record with the secondary alias. In some embodiments, associating a secondary alias with the alias pattern may include at least one of generating a secondary alias responsive to the alias pattern not being located in an alias pattern database, and determining the secondary alias associated with the alias pattern responsive to the alias pattern being located in the alias pattern database.

In an embodiment, a computer-implemented method for de-identifying information may include, by a processor, accessing at least one record comprising at least one information element, generating at least one direct alias based on the at least one information element, the at least one direct alias forming an alias pattern associated with the at least one record, associating a secondary alias with the alias pattern, and generating a de-identified record by replacing the at least one information element of the at least one record with the secondary alias. In some embodiments, associating a secondary alias with the alias pattern may include at least one of generating a secondary alias responsive to the alias pattern not being located in an alias pattern database, and determining the secondary alias associated with the alias pattern responsive to the alias pattern being located in the alias pattern database.

In an embodiment, a system for de-identifying information may include a processor and a non-transitory, computer-readable storage medium in operable communication with the processor. The computer-readable storage medium may include one or more programming instructions that, when executed, cause the processor to access at least one record comprising at least one information element, the at least one information element comprising a date event, determine a day zero value associated with the at least one record, determine a chronology value associated with the at least one record by calculating a duration between the date event and the day zero value, and generate a de-identified record by replacing the date event with the chronology value.

### DETAILED DESCRIPTION

The described technology generally relates to systems, methods, and non-transitory computer-readable media for processing information to generate de-identified information. In general, de-identified information includes information that does not contain personally identifiable elements that may identify or reasonably be used to identify an individual.

Personally identifiable elements (or “identifiable elements”) may comprise information elements, such as names, addresses, ages, address information, demographic information, financial information, occupational information, dates, times, or the like. Identifiable elements may identify an individual or may reasonably be used to identify an individual indirectly. An information record may include personally identifiable elements and non-personally identifiable elements (or “non-identifiable elements”). A non-identifiable element may generally include information that cannot be used to identify an individual or reasonably identify an individual indirectly. For example, an information record of a bank customer financial transaction may include the identifiable elements of customer name, customer account number, and primary branch, and the non-identifiable elements of transaction type (for instance, withdrawal, deposit, or the like) and amount. In another example, an information record associated with a patient of a healthcare facility may include the identifiable elements of patient name and address and a date of a medical procedure, and the non-identifiable elements of diagnosis, treatment regimen, and treatment outcome.

Although certain information elements may be described as being one of identifiable or non-identifiable in examples provided herein, embodiments are not so limited because the classification of a particular information element may depend on the particular configuration of the system or method for de-identifying information according to some embodiments. Accordingly, the specification of a type or category of information as being an identifiable element or a non-identifiable element may be configured in an information de-identification system or method according to some embodiments. For instance, age (other than individuals that are age 90 and above) and occupational information are not considered identifiable elements that must be removed under HIPAA in the creation of a de-identified record set. In another instance, maintaining the identity of healthcare providers (i.e., doctors, hospitals, or the like) within the medical record is not prohibited under HIPAA and actually operates to maintain the value of a de-identified data set. Accordingly, a system or method configured to de-identify information to comply with HIPAA according to some embodiments may categorize age, occupational information, and healthcare provider information elements as being non-identifiable elements. Alternatively, a consumer research study may require de-identified information that does not include age information and occupational information. As such, a system or method configured to de-identify information to comply with the consumer research study according to some embodiments may categorize age and occupational information elements as being identifiable elements.

Although health information and financial information are used as examples herein, embodiments are not so limited, as any form, category, or other type of information may be de-identified according to some embodiments.

In some embodiments, de-identified information may be generated by removing identifiable elements from an information record. In some embodiments, identifiable elements may be removed from an information record by scrubbing, deleting, or otherwise removing the identifiable elements from the information record. In some embodiments, identifiable elements may be removed from an information record by replacing the identifiable elements with non-identifiable elements. In some embodiments, non-identifiable elements used to replace identifiable elements may include an alias of the identifiable elements that are being replaced. In general, an alias is a non-identifiable element generated based on an identifiable element for example, by encoding, transforming, converting, encrypting, scrambling, or otherwise modifying the identifiable element. In some embodiments, non-identifiable elements used to replace identifiable elements may not be related to the identifiable elements they are replacing (“non-alias” non-identifiable elements).

In some embodiments, direct aliases may be generated for each of the identifiable elements of an information record. An alias pattern may be created by replacing the identifiable elements with the direct aliases. A database of alias patterns may be searched to determine whether the alias pattern already exists in the database (i.e., the information record is associated with a previous information record). If the alias pattern does not exist in the database, then a secondary alias is generated and associated with the alias pattern. If the alias pattern does exist in the database, then the associated secondary alias is retrieved from the database. A de-identified record may be generated by redacting each of the identifiable elements and adding a new field with the secondary alias. In this manner, a de-identified record may be created that includes de-identified elements (i.e., the secondary aliases) that were not generated directly from identifiable elements and that can be aggregated and matched with related records.

Healthcare providers rely on access to patient medical records. Each time that a patient visits or otherwise interacts with a healthcare provider, a separate and unique medical record is created and/or an existing medical record associated with the patient is modified. In addition, a patient's medical records are often duplicated for each healthcare provider entity. For instance, a hospital system may have a set of records for a patient relating to a particular injury treated at the hospital. In another instance, a physician's office may have another set of records for the same patient relating to office visits. Accordingly, separate instances of a single individual's medical record may exist in multiple disparate data silos.

Patient medical records may also be used in research and development. In general, the medical industry uses de-identified or anonymized medical records for medical research, pharmaceutical development, and many other functions pertaining to the expansion and improvement of the quality of health and wellness. These industry initiatives benefit from robust and accurate de-identified data sets. For example, “deeper” and more “longitudinal” de-identified medical records in a data set provide increased benefits for a medical research project. Therefore, if separate instances of a single individual medical record exist in multiple distinct data silos, data aggregation of these medical records to create a single longitudinal de-identified record may improve clinical research outcomes. The generation and use of such de-identified records in the healthcare and medical research fields is regulated according to HIPAA and its specific rules relating to the generation and use of de-identification medical records. HIPAA refers to identifiable elements associated with patient information as “protected health information” (PHI) and defines de-identified information as “health information that does not identify an individual and with respect to which there is no reasonable basis to believe that the information can be used to identify an individual.” HIPAA at §164.514. The HIPAA rules relating to the generation and use of de-identified information from PHI include, among other things, the following: (1) PHI may be used for the purposes of de-identification; (2) PHI is not explicitly allowed to be aggregated and then de-identified for the intent of commercialization; (3) PHI is not restricted from being de-identified and then aggregated for the intent of commercialization; (4) before PHI may be transferred to certain third parties, such as non-authorized third parties, the identifiable elements must be removed; (5) an alias may be created to identify a particular record in a de-identified data set; (6) an alias generated using identifiable elements may not be included in a de-identified data set conveyed to a non-authorized third party; and (7) month and day attributes of dates of de-identified records must be removed.

Although HIPAA is effective at protecting patient medical information, the rules are a barrier to creating longitudinal de-identified records. For example, conventional de-identification technology does not enable data users to create a de-identified data set and subsequently aggregate or insert successive instances of de-identified records into the de-identified data set. In another example, removing month and day attributes of patient medical information does not enable data users to maintain a chronology of events associated with the de-identified records, particularly in intervals that occur in less than one-year periods. For instance, if two patient records are associated with medical events that occurred on Jan. 1, 2015 and Jul. 1, 2015, the corresponding de-identified records may only indicate that the medical events occurred in 2015. Accordingly, a data user would not be able to determine a sequence of the medical events. In another instance, two patient records are associated with a first medical event that occurred on Dec. 30, 2015 and a second medical event that occurred on Jan. 1, 2016. The corresponding de-identified records would indicate that the first medical event occurred in 2015 and the second medical event occurred in 2016. Although a data user may be able to ascertain a chronological order for the first medical event and the second medical event, the data user would not be able to determine how much time accrued between the two medical events. Accordingly, removal of day and month attributes may eliminate the ability to sequence events accurately when records are aggregated. Information pertaining to the chronology of medical events and/or time duration between medical events may be important for various reasons, including determining causality of medical events (e.g., whether the patient exhibited symptom x before or after taking medication y and/or how soon after starting to take medication y)

After a medical record is de-identified, it no longer includes identifying characteristics of the record. However, an alias may be created using one or more identifiable elements of the original medical record that uniquely identifies a particular patient's record each subsequent time the record or related records are encountered. Under HIPAA, this alias can be used to enable ongoing aggregation or insertion of subsequently encountered instances of a patient's medical record by the party authorized to have access to the identifiable record, but not by a non-authorized third party. However, when the de-identified data set is conveyed to a non-authorized third party, the alias must be removed to remain in compliance with HIPAA. Therefore, the ability to further aggregate or insert newly de-identified instances of a particular medical record into the resulting de-identified data set is lost.

Systems and methods described according to some embodiments provide for the de-identification of data that complies with HIPAA and allows for subsequent aggregation and the insertion of successive de-identified instances of medical records. For instance, embodiments may provide for a regulatory-compliant system for de-identifying PHI and allowing various entities (including, for example, authorized third parties and un-authorized third parties) to access de-identified medical information and to aggregate multiple newly formed de-identified records together and/or to insert newly formed de-identified records into an existing, previously de-identified data set. In another instance, some embodiments allow an entity to form and/or access a single, aggregated, longitudinal and accurate de-identified version of a patient's medical record.

Systems and methods described according to some embodiments may replace dates and/or portions thereof related to events in a patient record with a sequential number that represents a duration of time since an event (“chronology value”). In some embodiments, a chronology value may be determined by setting a particular date as a starting point (“day zero”) and counting the number of days from day zero to the date of a particular event. In some embodiments, day zero may be a date of diagnosis, a date on which a patient record was created, or any other date capable of operating according to some embodiments. In some embodiments when the final de-identified data set is generated, the day and month of events are redacted or otherwise removed. As such, each event that is represented in any individual data set may have its own associated chronology value. When different data sets are aggregated together, these chronology values may enable the aggregated data set to maintain an accurate, sequential chronology of the events within the merged record, without conveying the actual date of the event.

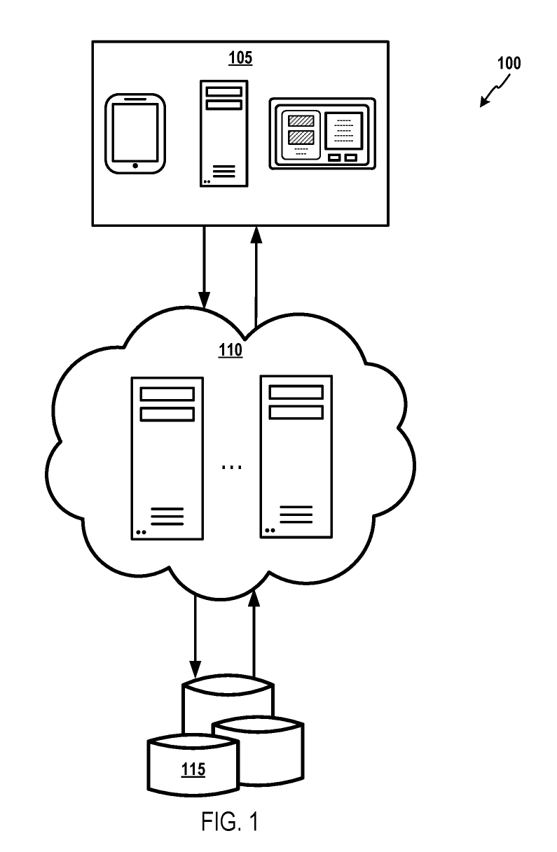

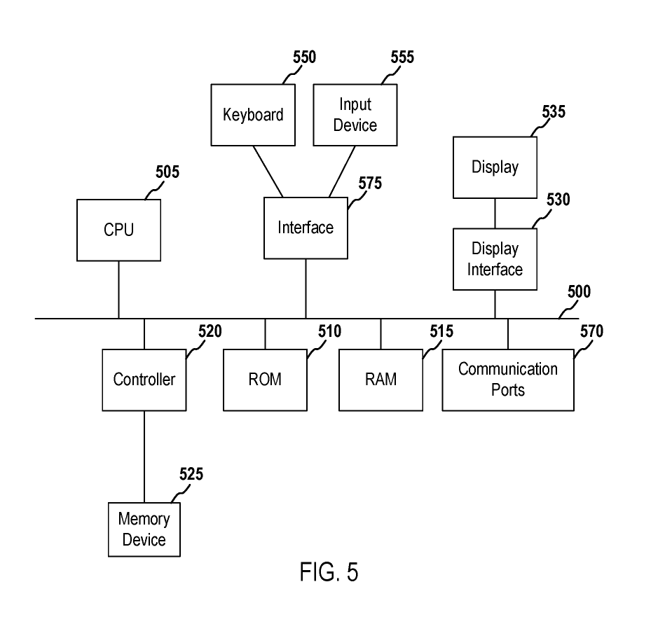

FIG. 1 depicts an illustrative information management system according to an embodiment. As shown in FIG. 1, the healthcare information management system (the “management system”) 100 may include one or more server logic devices 110, which may generally include a processor, a non-transitory memory or other storage device for housing programming instructions, data or information regarding one or more applications, and other hardware, including, for example, the central processing unit (CPU) 505, read only memory (ROM) 510, random access memory (RAM) 515, communication ports 570, controller 520, and/or memory device 525 depicted in FIG. 5 and described below in reference thereto.

In some embodiments, the programming instructions may include an information management application (the “management application”) configured to, among other things, de-identify information received or otherwise accessed by the management system 100. The server logic devices 110 may be in operable communication with client logic devices 105, including, but not limited to, server computing devices, personal computers (PCs), kiosk computing devices, mobile computing devices, laptop computers, smartphones, personal digital assistants (PDAs), tablet computing devices, or any other logic and/or computing devices.

In some embodiments, the management application may be accessible through various platforms, such as a client application, web-based application, over the Internet, and/or a mobile application (for example, a “mobile app” or “app”). According to some embodiments, the management application may be configured to operate on each client logic device 105 and/or to operate on a server logic device 110 accessible to client logic devices over a network, such as the Internet. All or some of the files, data and/or processes (for example, source information, de-identification processes, data sets, or the like) used for accessing and/or de-identifying information may be stored locally on each client logic device 105 and/or stored in a central location and accessible over a network.

In an embodiment, one or more data stores 115 may be accessible by the client logic devices 105 and/or the server logic devices 110. The data stores 115 may include information sources that may include information for de-identification through the management application. In a non-limiting example in which the management system 100 is configured to de-identify healthcare information, at least a portion of the data stores 115 may include information associated with a healthcare information system, including, without limitation, healthcare information and management systems (HIMS), electronic medical record (EMR) systems, radiology information systems (RIS), picture archiving and communications system (PACS), Medicaid Management Information Systems (MMIS), health insurance provider systems, clinical research information systems, and/or the like. In another non-limiting example in which the management system 100 is configured to de-identify customer information, at least a portion of the data stores 115 may include a customer relationship manager (CRM) system, an enterprise resource planning (ERP) system, customer databases, or the like. In some embodiments, the data stores 115 may include information obtained from multiple data sources, including third-party data sources.

Although the one or more data stores 115 are depicted as being separate from the logic devices 105, 110, embodiments are not so limited, as all or some of the one or more data stores may be stored in one or more of the logic devices.

As described in more detail below, the management application may access personally identifiable information (PII) or PHI, information that is not de-identified, and/or processes stored in the data stores 115 and generate de-identified information from such information. For example, the management system 100 may access a hospital EMR data source 115 that includes PII in the form of patient medical records. The management application may de-identify the PII to generate a de-identified data set, which may be accessed by a data consumer, such as a clinical research facility, through a client logic device 105. In some embodiments, the management system 100 may include and/or be in communication with a network, such as the Internet or a cloud-computing system (the “cloud”). In some embodiments, the de-identified information generated by the management system 100 may be stored in the cloud and accessed by data consumers through a web-based interface or other portal to the cloud.

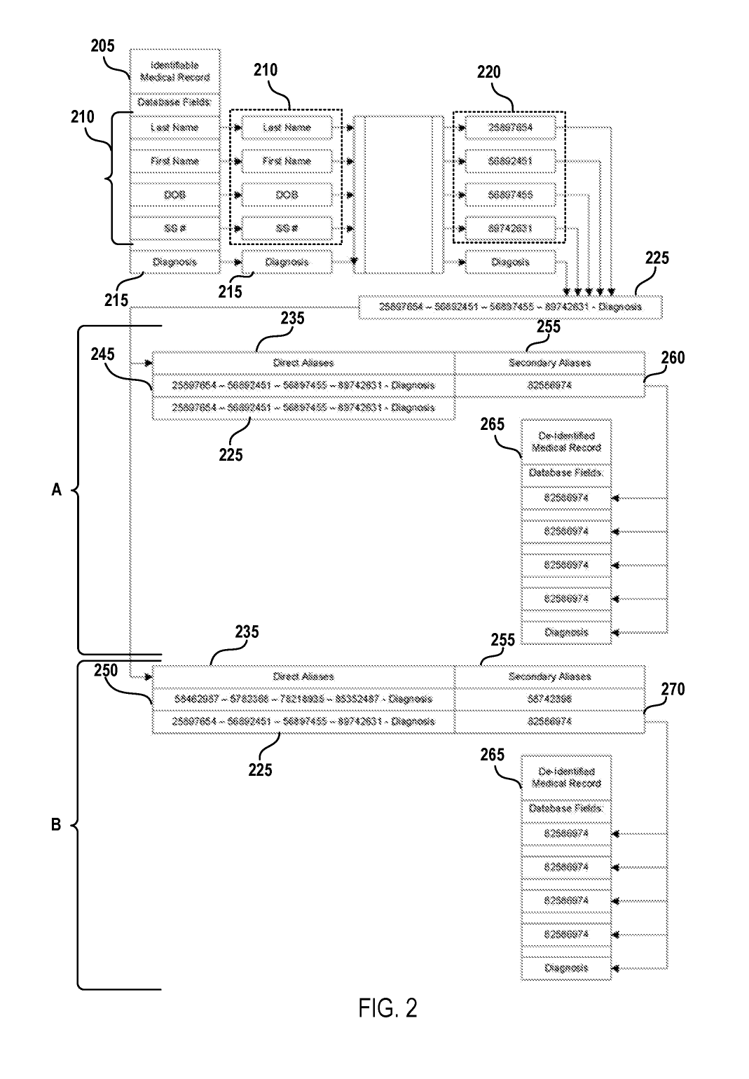

FIG. 2 depicts a block diagram for de-identifying information according to some embodiments. As shown in FIG. 2, a medical record 205 may include one or more identifiable elements 210 and, for example, a non-identifiable element 215. The one or more identifiable elements 210 may be individually and separately transformed into direct aliases 220, which are aliases generated directly based on the identifiable elements. In some embodiments, the one or more identifiable elements 210 are not concatenated before being processed to generate direct aliases 220 such that individual direct aliases are generated for each identifiable element. The direct aliases 220 may be generated using various methods, such as via encryption, translation, encoding, table look-ups, hash functions, or other processes. For example, the character string of an identifiable element 210 may be processed using an algorithm to generate a corresponding direct alias 220. In some embodiments, identical identifiable elements 210 may generate identical direct aliases 220. For instance, the identifiable element 210 “ABC” may always generate the direct alias 220 “123.” In some embodiments, identical identifiable elements 210 may not generate identical direct aliases 220. For instance, a time stamp, random number, or other component may be used, for example, as a seed value such that identical identifiable elements 210 do not generate identical direct aliases 220. As described above, HIPAA prohibits data sets containing medical records 205 that include information elements with direct aliases 220 from being shared with certain third parties, such as an unauthorized third party.

An alias pattern 225 (or “direct alias pattern”) may be generated by replacing the identifiable elements 210 in the medial record 205 with the corresponding direct aliases 220. The alias pattern 225 may include the direct aliases 220 in any combination, including, without limitation, in sequence. In some embodiments, the direct aliases 220 may form an identical alias pattern 225 for each instance of the medical record 205. In some embodiments, the alias pattern 225 may include one or more non-identifiable elements 215. In some embodiments, the alias pattern 225 may only include the direct aliases 220. An alias database 235 (or “translation table”) may include direct alias patterns 245, 250 that have previously been created, for example, for a dataset stored in the management system 100. The alias database 235 may also include secondary aliases 255 that are associated with the alias patterns 225, 245, 250. In some embodiments, each secondary alias 255 may be unique.

The alias database 235 may be searched, for example, by the management application, to determine if the alias pattern 225 is located in the alias database. If the alias pattern 225 does not exist in the alias database 235, then the alias pattern is associated with a new medical record. If the alias pattern 225 does exist in the alias database 235, then the alias pattern is associated with a medical record that already exists in a data set.

In section A of FIG. 2, alias pattern 225 matches alias pattern 245 such that a secondary alias 255 exists in the alias database 235. In some embodiments, a de-identified record 265 may be generated by redacting or replacing the identifiable elements 210 of the medical record. In embodiments where at least one identifiable element 210 is redacted, a new field with the secondary alias 260 may be added to the de-identified record 265. In embodiments, where at least one identifiable element 210 is replaced, the identifiable element may be replaced with the secondary alias 260. In various embodiments, the de-identified record 265 may include more, fewer, or the same number of fields as the medical record 205. For example, each of the identifiable elements 210 may be replaced by the corresponding secondary alias 260. Alternately, each identifiable element 210 may be redacted and a new field with the secondary alias 260 may be added, resulting in fewer fields in the de-identified record 265. The secondary alias 260 of the de-identified record 265 may be used, for example, by a third party to efficiently and accurately aggregate subsequent instances of a related (i.e., same patient) de-identified record into an existing de-identified data set.

In some embodiments, the de-identified record 265 may include a different number of fields than the medical record 205. For example, each of the identifiable elements 210 may be removed and replaced by a single field having the corresponding secondary alias 260. In some embodiments, the direct aliases 220 may be removed from the medical record 205 as part of generating the de-identified record 265.

In section B of FIG. 2, alias pattern 225 does not match an alias pattern in the alias database 235. Accordingly, a new secondary alias 270 may be generated and associated in the alias database 235 with the alias pattern 225. In some embodiments, the secondary alias 270 may be generated based on information included in the medical record 205. In some embodiments, the secondary alias 270 may not be related to information included in the medical record 205. In some embodiments, the secondary alias 270 may be arbitrarily derived and/or assigned to the alias pattern 225. In some embodiments, a de-identified record 265 may be generated by replacing the identifiable elements 210 of the medical record with the secondary alias 270 according to some embodiments. In some embodiments, a de-identified record 265 may be generated by replacing the identifiable elements 210 and any other identifiable elements that are a part of the patient record and are required to be removed in the creation of a de-identified record with the secondary alias 270 according to some embodiments.

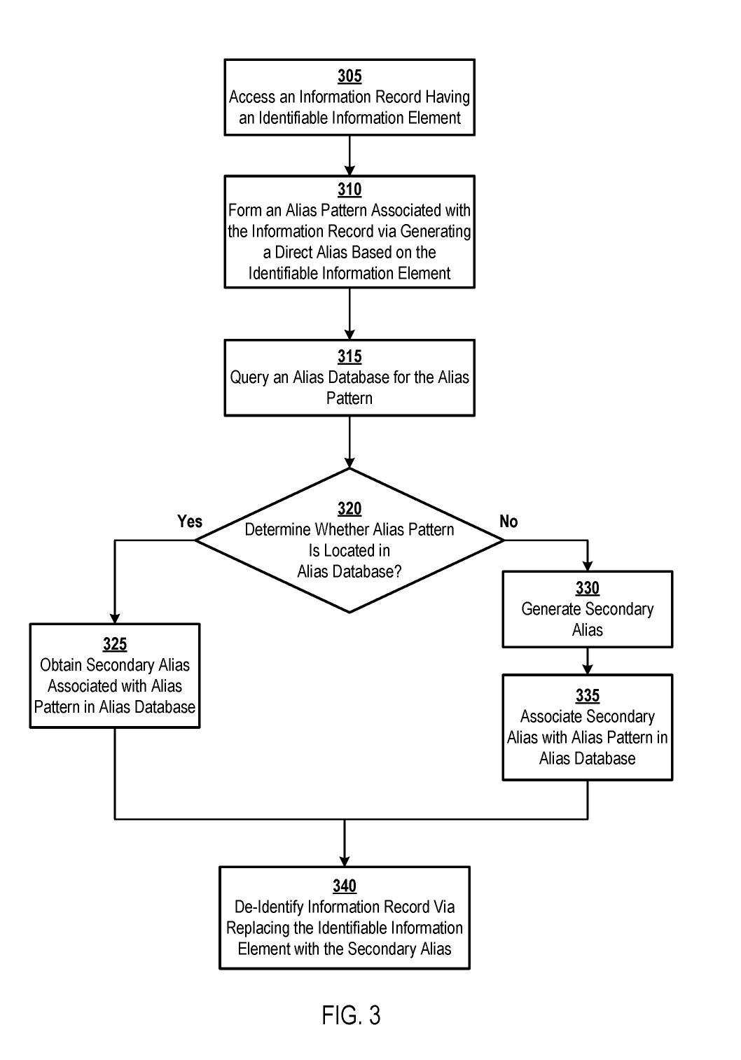

FIG. 3 depicts a flow diagram for an illustrative method of generating de-identified information by the management system 100, such as through one or more client logic devices 105 and/or server logic devices 110, arranged in accordance with at least some embodiments described herein. Illustrative methods may include one or more operations, functions or actions as illustrated by one or more of blocks 305, 310, 315, 320, 325, 330, 335, and/or 340. The operations described in blocks 305-340 may also be stored as computer-executable instructions in a computer-readable medium, such as one or more of the memory elements 510, 515, and 525 depicted in FIG. 5. Although illustrated as discrete blocks, various blocks may be divided into additional blocks, combined into fewer blocks, or eliminated, depending on the desired implementation.

As shown in FIG. 3, a logic device 105, 110 of the management system 100 may access 305 an information record having an identifiable information element. An alias pattern may be formed 310 that is associated with the information record by generating a direct alias based on the identifiable information element. For example, a direct alias may be generated directly from the identifiable information element via an algorithm that translates, transforms, converts, encodes, or otherwise processes the character string in the identifiable information element to generate a related character string that cannot be used to identify an individual associated with the information record. In some embodiments, an information record that includes a plurality of identifiable information elements may be accessed 305. In such embodiments, direct aliases may be formed 310 for each of the plurality of identifiable information elements via the algorithm. The alias pattern may be formed 310 using the direct aliases for the plurality of identifiable information elements. Similar operations may be performed to replace or redact identifiable information elements will be apparent to those of ordinary skill in the art.

An alias database may be queried 315 for the alias pattern. For example, a logic device 105, 110 of the management system 100 may include or may have access to an alias database that includes alias patterns that have been generated by the management system or one or more other systems. A logic device 105, 110 of management system 100 may query 315 the alias database to determine whether the alias pattern exists within the volume of accessible alias patterns. If it is determined 320 that the alias pattern is located in the alias database, then the secondary alias associated with the alias pattern is obtained 325 from the alias database. If it is determined 320 that the alias pattern is not located in the alias database, the alias pattern is added to the alias database, a secondary alias is generated 330, and the secondary alias is associated 335 with the alias pattern in the alias database. In some embodiments, the secondary alias may be generated 330 via a random or pseudorandom process. In some embodiments, the information record is de-identified 340 by replacing the identifiable information elements with the secondary alias. In some embodiments, the information record is de-identified 340 by redacting the identifiable information elements from the information record and adding a secondary alias field with the secondary alias to the information record. In some embodiments, a day zero value may be generated for the information record. In some embodiments, the day zero value may be set to a date prior to the date of birth of the individual associated with the information record, such as, for example, at least fifty years prior to the individual's date of birth. In some embodiments, the day zero value may be set to the date of a particular event, such as a date of birth of the patient, a date of a medical diagnosis, a date of admission to a healthcare facility, a date on which a treatment was started, or the like. The day zero value may be associated with the secondary alias in the alias database.

In some embodiments, methods and systems described herein may be configured to perform a date conversion process to remove date information from information records. Non-limiting examples of date information may include month information, day information, and/or year information, such as a date associated with the information record that includes a month, day, and/or year element (e.g., Jan. 1, 2015) (a “date event”). In some embodiments, the date conversion process may be configured to replace date information with chronology value information. In some embodiments, the chronology value information may include a sequential number that represents a duration since the date associated with the day zero value.

In some embodiments, day zero may be a date associated with a patient related to the information record being de-identified, such as a date of diagnosis. In some embodiments, day zero may be a date specified for a group of records and/or de-identified information. For instance, day zero may be specified as Jan. 1, 1980 for all records in a group of records. In this manner, all records in a group may have corresponding chronological information with respect to day zero. In some embodiments, the value of day zero may be redacted, deleted, or otherwise made unavailable in the de-identified information so that date events may not be determined based on the chronology value and day zero. In some embodiments, day zero may be labeled or otherwise associated with a day zero identifier so that de-identified data with the same day zero may be identified. In some embodiments, the day zero identifier may be selected such that the date of day zero may not be determined. For example, a day zero of Jan. 1, 1980 may have a day zero identifier of “abc123.” Accordingly, any data set de-identified using a day zero with a day zero identifier of abc123 will have chronology values calculated based on the same day zero.

The chronology value may be expressed in various time units, including, without limitation, hours, days, weeks, months, and/or any other time interval capable of operating according to some embodiments. In some embodiments, the chronology value for an information record may be determined by calculating the duration in time units from day zero to the date event. In some embodiments, the chronology value for an information record may be determined by subtracting day zero from the date event according to date subtraction techniques known to those having ordinary skill in the art. For example, if day zero is Jan. 1, 2014 and the date event is Jan. 1, 2015, the chronology value may be 365 in day units, 8760 in hour units, or the like.

When a de-identified data set is generated according to some embodiments, the day and month of the individual's date of birth may be redacted. Therefore, each event that is represented in any individual data may have its own affiliated chronology value. When different data sets are aggregated together, these chronology values may enable the aggregated data set to maintain an accurate, sequential chronology of the events within the merged record, without conveying the actual date of the event. For instance, the events in any two aggregated records may co-exist and maintain a mutual chronological and sequential accuracy after the merging of the records. In some embodiments, a plurality of fields of an information record may be redacted or removed, and a chronology value may be added to the information record. In such embodiments, the chronology value may be determined based on the day zero value for the information record. In some embodiments, an individual's year of birth may be removed, such as if the individual is at least 90 years old. In some embodiments, additional fields may be removed in accordance with one or more regulations, laws, or business requirements.

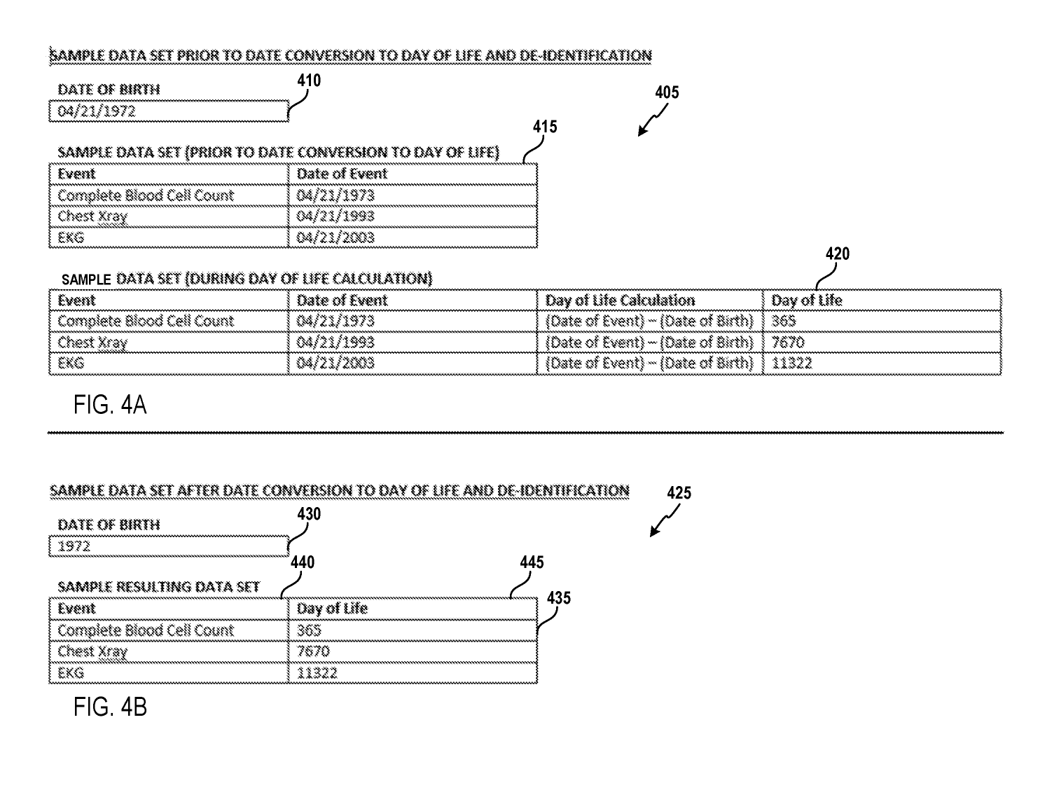

FIG. 4A depicts an illustrative sample data set that includes date and time information and FIG. 4B depicts an illustrative data set de-identified according to some embodiments. As shown in FIG. 4A, an information record 405 that includes PHI may have various information elements, such as a date of birth 410, a sample data set of medical events 415, and a sample date set for calculating chronology values 420. As shown in FIG. 4B, a sample de-identified record 425 may include a date of birth information element 430 that only includes the year of birth value. The de-identified record 425 may also include a sample data set 435 that includes events 440 and corresponding chronology values 445.

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 510 and random access memory (RAM) 515 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, data, or files.

Program instructions, software or interactive modules for performing any of the functional steps associated with the generation of de-identified information as described above may be stored in the ROM 510 and/or the RAM 515. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. The information may include information related to a current job ticket and associated tasks. Communication with external devices may occur using various communication ports 570. An exemplary communication port 570 may be attached to a communications network, such as the Internet or a local area network.

The hardware may also include an interface 545 that allows for receipt of data from input devices such as a keyboard 550 or other input device 555 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by some embodiments described herein.

What is claimed is:

1. A system for de-identifying information, the system comprising:
a processor; and
a non-transitory, computer-readable storage medium in operable communication with the processor, wherein the computer-readable storage medium contains one or more programming instructions that, when executed, cause the processor to:
access at least one record comprising at least one information element,
generate at least one direct alias based on the at least one information element, the at least one direct alias forming an alias pattern associated with the at least one record,
associate a secondary alias with the alias pattern by performing at least one of:
generating a secondary alias responsive to the alias pattern not being located in an alias pattern database, and
determining the secondary alias associated with the alias pattern responsive to the alias pattern being located in the alias pattern database, and
generate a de-identified record by replacing the at least one information element of the at least one record with the secondary alias.

2. The system of claim 1, wherein the at least one record comprises at least one health record.

3. The system of claim 1, wherein the at least one record comprises at least one financial record.

4. The system of claim 1, wherein the computer-readable storage medium further contains one or more programming instructions that, when executed, cause the processor to determine a day zero value associated with the at least one record.

5. The system of claim 4, wherein the computer-readable storage medium further contains one or more programming instructions that, when executed, cause the processor to determine a chronology value associated with the at least one record by calculating a duration between the date event and the day zero value.

6. The system of claim 5, wherein the computer-readable storage medium further contains one or more programming instructions that, when executed, cause the processor to generate the de-identified record by replacing the date event with the chronology value.

7. A computer-implemented method for de-identifying information, the method comprising, by a processor:
accessing at least one record comprising at least one information element;
generating at least one direct alias based on the at least one information element, the at least one direct alias forming an alias pattern associated with the at least one record;
associating a secondary alias with the alias pattern by performing at least one of:
generating a secondary alias responsive to the alias pattern not being located in an alias pattern database, and
determining the secondary alias associated with the alias pattern responsive to the alias pattern being located in the alias pattern database; and
generating a de-identified record by replacing the at least one information element of the at least one record with the secondary alias.

8. The method of claim 7, wherein the at least one record comprises at least one health record.

9. The method of claim 7, wherein the at least one record comprises at least one financial record.

10. The method of claim 7, further comprising determining a day zero value associated with the at least one record.

11. The method of claim 10, further comprising determining a chronology value associated with the at least one record by calculating a duration between the date event and the day zero value.

12. The method of claim 11, wherein generating the de-identified record further comprises replacing the date event with the chronology value.

13. A system for de-identifying information, the system comprising:
a processor; and
a non-transitory, computer-readable storage medium in operable communication with the processor, wherein the computer-readable storage medium contains one or more programming instructions that, when executed, cause the processor to:
access at least one record comprising at least one information element, the at least one information element comprising a date event,
determine a day zero value associated with the at least one record,
determine a chronology value associated with the at least one record by calculating a duration between the date event and the day zero value, and
generate a de-identified record by replacing the date event with the chronology value.

14. The system of claim 13, wherein the day zero value comprises a birth date.

15. The system of claim 13, wherein the at least one record comprises a health record and the day zero value comprises at least one of a date of diagnosis and a date patient record was created.

16. The system of claim 13, wherein the at least one record comprises a plurality of records associated with a plurality of individuals,
wherein the day zero value has a same value for each of the plurality of records.
